(19) United States
(12) Patent Application Publication
(10) Pub. No.: US 2012/0315069 A1
(43) Pub. Date: Dec. 13, 2012

(54) COOLING DEVICE AND IMAGE FORMING APPARATUS INCLUDING SAME

(76) Inventors: KEISUKE IKEDA, Kanagawa (JP); SATOSHI OKANO, Kanagawa (JP); TOMOYASU HIRASAWA, Kanagawa (JP); MASANORI SAITOH, Tokyo (JP); TAKEHARA KENICHI, Kanagawa (JP); HIROMITSU FUJIYA, Kanagawa (JP)

(21) Appl. No.: 13/463,081

(22) Filed: May 3, 2012

(30) Foreign Application Priority Data
Jun. 10, 2011 (JP) 2011-129927
Jul. 20, 2011 (JP) 2011-159165

(51) Int. Cl. G03G 15/20

(52) U.S. Cl. 399/341

(57) ABSTRACT

A cooling device including at least two cooling members to cool a recording medium passing thereover, a coolant circulation unit to circulate a coolant, and tubing that connects the coolant circulation unit to the cooling members and through which the coolant circulates. Each of the cooling members includes a heat-absorbing surface that directly contacts the recording medium or indirectly contacts the recording medium via a thermal transmission member, an internal channel provided within each of the cooling members through which the coolant circulates, and a channel inlet and outlet formed at downstream and upstream ends of each of the cooling members in a direction of conveyance of the recording medium, respectively. One of an interval and a thermal insulator is provided between the cooling members.

### CROSS-REFERENCE TO RELATED APPLICATIONS

The present patent application is based on and claims priority pursuant to 35 U.S.C. §119 from Japanese Patent Application Nos. 2011-129927, filed on Jun. 10, 2011 and 2011-159165, filed on Jul. 20, 2011, both in the Japan Patent Office, each of which is incorporated by reference herein in its entirety.

### BACKGROUND OF THE INVENTION

1. Field of the Invention

Exemplary aspects of the present invention generally relate to a cooling device for an image forming apparatus such as a printer, a facsimile machine, and a copier, and an image forming apparatus including the cooling device.

2. Description of the Related Art

Related-art image forming apparatuses, such as copiers, printers, facsimile machines, and multifunction devices having two or more of copying, printing, and facsimile capabilities, typically form a toner image on a recording medium (e.g., a sheet of paper, etc.) according to image data using an electrophotographic method. In such a method, for example, a charger charges a surface of an image carrier (e.g., a photoconductor); an irradiating device emits a light beam onto the charged surface of the photoconductor to form an electrostatic latent image on the photoconductor according to the image data; a developing device develops the electrostatic latent image with a developer (e.g., toner) to form a toner image on the photoconductor; a transfer device transfers the toner image formed on the photoconductor onto a sheet of recording media; and a fixing device applies heat and pressure to the sheet bearing the toner image to fix the toner image onto the sheet. The sheet bearing the fixed toner image is then discharged from the image forming apparatus.

Although differing depending on types of toner and types and speed of conveyance of the sheet, the fixing device is generally controlled to have a temperature of about 18° C.° to 200C.° so as to instantly melt toner and fix the toner image onto the sheet. Therefore, the temperature of the sheet immediately after passing through the fixing device is high, typically about 10° C.° to 130C.° depending on the thermal capacity of each sheet such as specific heat and density. Because the melting point of toner is lower than the temperature of the sheet heated by the fixing device, the toner on the sheet is still slightly soft immediately after the sheet has passed through the fixing device, and remains adhesive until the sheet is sufficiently cooled. Consequently, in a case in which multiple sheets discharged from the fixing device are sequentially stacked one atop the other on a discharge tray during continuous image formation, such soft toner on one sheet may adhere to the next sheet, resulting in blocking and considerable image degradation.

In addition, when multiple sheets that are still warm are sequentially stacked one atop the other on the discharge tray after being discharged from the fixing device, the heat retained by the stacked sheets softens the toner on the sheets and the weight of the stacked sheets compresses the sheet and possibly causing them to stick together. If stuck sheets are forcibly separated, the toner images formed on the sheets may be damaged or destroyed. For these reasons, the sheets after the fixing process need to be sufficiently cooled.

There is known a cooling device including a single cooling member that contacts an inner circumference of an endless conveyance belt that conveys the sheet. The cooling member absorbs heat via the conveyance belt from the sheet conveyed by the conveyance belt to cool the sheet discharged from the fixing device. The sheet heated by the fixing device is cooled by the cooling member while being conveyed by the conveyance belt. Therefore, the temperature of the sheet is lowered as the sheet approaches a downstream portion of the cooling member in a direction of conveyance of the sheet.

With such a configuration, the amount of heat absorbed by the cooling member is also decreased toward the downstream portion of the cooling member. Therefore, an upstream portion of the cooling member is hotter than a downstream portion thereof. However, because a single cooling member is used to cool the sheet from upstream to downstream in the direction of conveyance of the sheet, heat from the hotter upstream portion of the cooling member is transmitted to the downstream portion. Consequently, the downstream end of the cooling member cannot be kept low, thereby degrading cooling efficiency and possibly preventing sufficient cooling of the sheet.

In another approach, an image forming apparatus includes a cooling device having a block-type cooling member provided downstream from the fixing device in the direction of conveyance of the sheet. A channel through which liquid coolant flows from downstream to upstream is formed inside the cooling member, and the cooling member contacts the sheet to cool the sheet while the sheet is conveyed past the cooling device. Thus, the sheet discharged from the fixing device is cooled by the cooling member included in the cooling device. Accordingly, toner on the sheet is also cooled and cured, thereby preventing blocking. The liquid coolant enters the cooling member from an inlet provided at a downstream end of the cooling member and flows through the channel to an outlet provided at an upstream end of the cooling member. Accordingly, the cooling member heated by heat absorbed from the sheet is cooled by the liquid coolant.

In a case in which the liquid coolant flows through the cooling member from upstream to downstream so as to cool the sheet, upstream and downstream portions of the cooling member sequentially absorb heat from the sheet. Consequently, the temperature of the liquid coolant flowing through the cooling member increases toward the downstream portion of the cooling member. As a result, a difference in temperature between the sheet and the liquid coolant flowing through the downstream portion of the cooling member also decreases, thereby degrading cooling efficiency.

By contrast, when the liquid coolant flows through the cooling member from downstream to upstream as described in the above example, the sheet can be cooled by the cooler liquid coolant at the downstream portion of the cooling member compared to the case in which the liquid coolant flows through the cooling member from upstream to downstream. As a result, the difference in temperature between the sheet and the liquid coolant flowing through the downstream portion of the cooling member can be increased, thereby efficiently cooling the sheet at the downstream portion of the cooling member.

However, again, because heat absorbed from the sheet by the upstream portion of the cooling member is transmitted to the downstream portion, the temperature of the liquid coolant flowing through the downstream portion of the cooling member is increased. Therefore, even in a configuration in which the liquid coolant flows through the cooling member from downstream to upstream, thermal transmission within the cooling member increases the temperature of the liquid coolant flowing through the downstream portion of the cooling member, thereby degrading cooling efficiency at the downstream portion of the cooling member.

### BRIEF SUMMARY OF THE INVENTION

In view of the foregoing, illustrative embodiments of the present invention provide a novel cooling device using a plurality of cooling members that efficiently cool a recording medium even at a downstream end of each of the cooling members in a direction of conveyance of the recording medium. In the cooling device, the cooling members are disposed such that heat-absorbing surfaces of the respective cooling members together form a single stepless plane. Illustrative embodiments of the present invention further provide an image forming apparatus including the cooling device.

In one illustrative embodiment, a cooling device includes at least two cooling members to cool a recording medium passing thereover, a coolant circulation unit to circulate a coolant, and tubing that connects the coolant circulation unit to the cooling members and through which the coolant circulates. Each of the cooling members includes a heat-absorbing surface that directly contacts the recording medium or indirectly contacts the recording medium via a thermal transmission member, an internal channel provided within each of the cooling members through which the coolant circulates, and a channel inlet and outlet formed at downstream and upstream ends of each of the cooling members in a direction of conveyance of the recording medium, respectively. One of an interval and a thermal insulator is provided between the cooling members.

In another illustrative embodiment, an image forming apparatus includes a fixing device to fix an image formed on a recording medium onto the recording medium using heat and the cooling device described above. The cooling device is provided downstream from the fixing device in the direction of conveyance of the recording medium to cool the recording medium onto which the image is fixed by the fixing device.

In yet another illustrative embodiment, a cooling device includes an endless belt to convey a recording medium contacting an outer circumference of the belt by movement of the belt, at least two cooling members arranged side by side at an interval therebetween in a direction of movement of the belt, and a positioning member to position the cooling members flush with each other to form a single plane. The cooling members respectively include heat-absorbing surfaces each contacting an inner circumference of the belt within a range in which the outer circumference of the belt contacts the recording medium to cool the recording medium by absorbing heat from the recording medium via the belt.

In still yet another example, an image forming apparatus includes a fixing device to fix an image formed on a recording medium onto the recording medium using heat and the cooling device described above. The cooling device is provided downstream from the fixing device in a direction of conveyance of the recording medium to cool the recording medium onto which the image is fixed by the fixing device.

Additional features and advantages of the present disclosure will become more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic vertical cross-sectional view illustrating an example of a configuration of a tandem-type full-color image forming apparatus employing an intermediate transfer belt system, in which a cooling device according to illustrative embodiments is installed;

FIG. 2 is schematic view illustrating an example of an overall configuration of a cooling device according to a first illustrative embodiment;

FIG. 3 is a schematic view illustrating an example of a configuration around one of cooling plates included in the cooling device;

FIG. 4 is a schematic view illustrating an example of a configuration around the other one of the cooling plates included in the cooling device;

FIG. 5(a) is a side view illustrating the configuration around the cooling plate;

FIG. 5(b) is a graph showing temperature distribution corresponding to the configuration illustrated in FIG. 5(a);

FIG. 6(a) is a side view illustrating an example of a configuration of a single cooling plate provided to a cooling device according to a comparative example;

FIG. 6(b) is a side view illustrating the configuration of the two separate cooling plates provided to the cooling device according to the first illustrative embodiment;

FIG. 6(c) is a graph showing temperature distribution corresponding to the configurations respectively illustrated in FIGS. 6(a) and 6(b);

FIG. 7 is schematic view illustrating an example of an overall configuration of the cooling device including a thermal insulator between the cooling plates;

FIG. 8 is a perspective view illustrating an example of a configuration around cooling plates included in a cooling device according to a second illustrative embodiment;

FIG. 9(a) is a side view illustrating the configuration around the cooling plates in the cooling device according to the second illustrative embodiment;

FIG. 9(b) is a graph showing temperature distribution corresponding to the configuration illustrated in FIG. 9(a);

FIG. 10 is a vertical cross-sectional view illustrating an example of a configuration of the cooling device according to the second illustrative embodiment in a case in which the cooling plates are not appropriately disposed;

FIGS. 11A and 11B are perspective views respectively illustrating positioning members provided to the cooling device according to the second illustrative embodiment;

FIG. 12 is a perspective view illustrating an example of a configuration of a positioning member having cutouts;

FIG. 13 is a vertical cross-sectional view illustrating an example of a configuration of a cooling device according to a first variation of the second illustrative embodiment;

FIG. 14 is a vertical cross-sectional view illustrating an example of a configuration of the cooling device illustrated in FIG. 13 in which the cooling plates are not appropriately disposed;

FIG. 15 is a perspective view illustrating an example of a configuration of the cooling plates and the positioning members included in the cooling device according to the first variation of the second illustrative embodiment;

FIG. 16 is a perspective view illustrating replacement of a cooling belt included in the cooling device according to the first variation of the second illustrative embodiment;

FIG. 17 is a perspective view illustrating an example of a configuration of a cooling device according to a second variation of the second illustrative embodiment;

FIG. 18 is a vertical cross-sectional view illustrating an example of a configuration of a cooling device according to a third illustrative embodiment;

FIG. 19 is a schematic view illustrating a flow of liquid coolant in the cooling device illustrated in FIG. 18;

FIG. 20 is a vertical cross-sectional view illustrating an example of a configuration of a cooling device according to a first variation of the third illustrative embodiment;

FIG. 21 is a schematic view illustrating an example of a configuration around cooling plates included in the cooling device illustrated in FIG. 20;

FIG. 22 is a schematic view illustrating an example of a configuration of a cooling device according to a second variation of the third illustrative embodiment;

FIG. 23 is a vertical cross-sectional view illustrating an example of a configuration of a cooling device according to a third variation of the third illustrative embodiment; and

FIG. 24 is a schematic view illustrating an example of a configuration around cooling plates included in the cooling device illustrated in FIG. 23.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

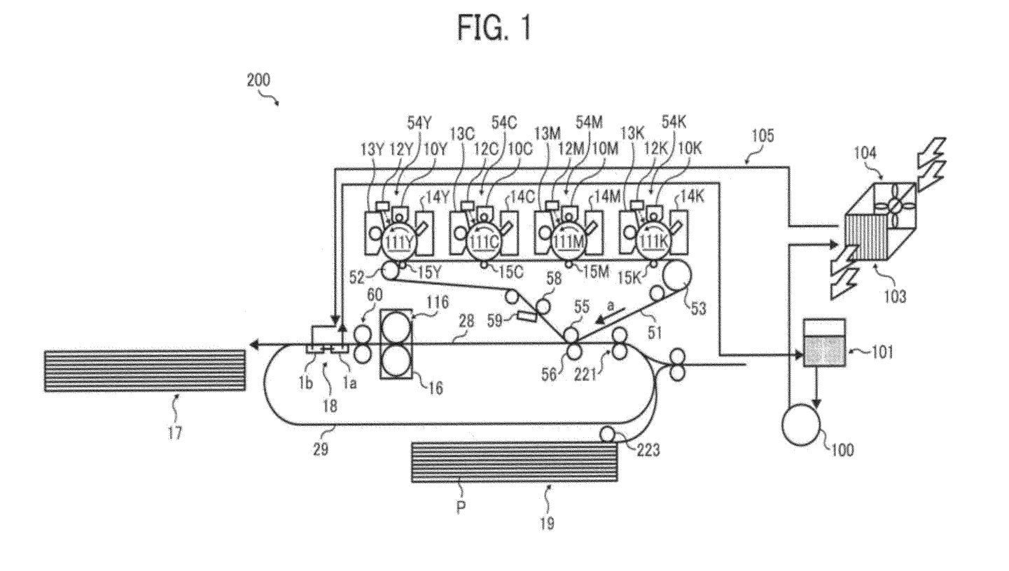

FIG. 1 is a schematic vertical cross-sectional view illustrating an example of a configuration of a tandem-type full-color image forming apparatus 200 employing an intermediate transfer belt system, in which a cooling device 18 according to illustrative embodiments is included.

It is to be noted that the cooling device 18 is applicable to any device in which cooling of a sheet-type member is needed as well as to image forming apparatuses. In addition, although liquid is used as a coolant in illustrative embodiments, the coolant is not limited thereto but may be any fluid, such as air.

The image forming apparatus 200 includes an intermediate transfer belt 51 wound around multiple rollers such as first, second, and third rollers 52, 53, and 55. The intermediate transfer belt 51 is rotated by rotation of the rollers 52, 53, and 55 in a clockwise direction as indicated by an arrow a in FIG. 1, and processing units for image formation are disposed around the intermediate transfer belt 51.

Part of the processing units, that is, image forming units 54Y, 54C, 54M, and 54K (hereinafter collectively referred to as image forming units 54), are disposed above the intermediate transfer belt 51 between the first and second rollers 52 and 53, in that order from upstream to downstream in the direction of rotation of the intermediate transfer belt 51. Taking the image forming unit 54Y as a representative example, a charger 10Y, an optical writing device 12Y, a developing device 13Y, and a cleaning device 14Y are provided around a drum-type photoconductor 111Y. The image forming unit 54Y further includes a primary transfer roller 15Y provided opposite the photoconductor 111Y with the intermediate transfer belt 51 interposed therebetween. It is to be noted that, the other three image forming units 54C, 54M, and 54K have the same configuration as the image forming unit 54Y, only differing in color of toner used. The image forming units 54 are arranged side by side at predetermined intervals.

Although each of optical writing devices 12Y, 12C, 12M, and 12K (hereinafter collectively referred to as optical writing devices 12) includes an LED as a light source, alternatively, a semiconductor laser may be used as the light source. The optical writing devices 12 irradiate photoconductors 111Y, 111C, 111M, and 111K (hereinafter collectively referred to as photoconductors 111) with light based on image data, respectively.

The image forming apparatus 200 further includes a sheet storage 19 that stores a sheet-type member such as a sheet P, a sheet feed roller 223, a pair of registration rollers 221, a secondary transfer roller 56, a belt cleaning device 59, a thermal fixing device 16, the cooling device 18, and a discharge storage 17, each of which is disposed below the intermediate transfer belt 51. The secondary transfer roller 56 is disposed opposite the third roller 55 with the intermediate transfer belt 51 interposed therebetween to transfer a toner image from the intermediate transfer belt 51 onto the sheet P. The belt cleaning device 59 that contacts an outer surface of the intermediate transfer belt 51 is provided opposite a roller 58 that contacts an inner surface of the intermediate transfer belt 51 so as to clean the outer surface of the intermediate transfer belt 51. The cooling device 18 includes cooling plates 1a and 1b, both of which cool the sheet P. The sheet P having a fixed toner image thereon is discharged to the discharge storage 17. A sheet conveyance path 28 is extended within the image forming apparatus 200 from the sheet storage 19 to the discharge storage 17. The image forming apparatus 200 further includes a sheet conveyance path 29 for duplex image formation that reverses the sheet P conveyed from the cooling device 18 and further conveys the sheet P to the pair of registration rollers 221 again when an image is formed also on a back side of the sheet P during duplex image formation.

The cooling device 18 includes the cooling plates 1a and 1b, a pump 100, a tank 101, a radiator 103, and a cooling fan 104. Each of the cooling plates 1a and 1b is a heat absorber that absorbs heat from the sheet P. The tank 101 is a storage device that stores a liquid coolant. Tubing 105 consisting of subsections 105a-105c is connected to an inlet and outlet provided to each of the cooling plates 1a and 1b, and connects the cooling plates 1a and 1b, the radiator 103, the tank 101, and the pump 100 so that the liquid coolant is circulated in the cooling device 18. The pump 100 is a coolant circulation unit that conveys the liquid coolant stored in the tank 101 through the tubing 105. The radiator 103 is a heat releasing part that releases heat absorbed from the sheet P by the liquid coolant via the cooling plates 1a and 1b outside the image forming apparatus 200. The cooling fan 104 is an air generator mounted on the radiator 103 to generate air flow around the radiator 103 to cool the radiator 103.

As indicated by solid arrows in FIG. 1 each representing the tubing 105, the liquid coolant cooled by the radiator 103 is supplied to the cooling plates 1b and 1a, flows through the cooling plates 1b and 1a, and then is discharged from the cooling plates 1b and 1a. The liquid coolant thus discharged is conveyed to the tank 101 and the pump 100 and is returned to the radiator 103 again to be cooled. The liquid coolant is circulated by rotational pressure from the pump 100, and heat is released from the liquid coolant by the radiator 103, which in turn cools the cooling plates 1a and 1b. The capacity of the pump 100 to convey the liquid coolant and the size of the radiator 103 are determined by thermal design considerations such as an amount of cooling required of the cooling plates 1a and 1b.

Taking the image forming unit 54Y as a representative example, image forming processes performed in the image forming apparatus 200 are described in detail below. In the same way as the general electrophotographic method, first, the surface of the photoconductor 111Y is evenly charged by the charger 10Y. The optical writing unit 12Y irradiates the charged surface of the photoconductor 111Y with light to form an electrostatic latent image on the surface of the photoconductor 111Y. Then, the developing device 13Y develops the electrostatic latent image with toner so that a toner image is formed on the surface of the photoconductor 111Y. The toner image is then primarily transferred from the surface of the photoconductor 111Y onto the intermediate transfer belt 51 by the primary transfer roller 15Y to which a transfer bias is supplied. Thereafter, the surface of the photoconductor 111y is cleaned by the cleaning device 14Y. The above-described image forming processes are also performed in the other three image forming units 54C, 54M, and 54K, differing only the color of toner used.

Developing devices 13Y, 13C, 13M, and 13K (hereinafter collectively referred to as developing devices 13) included in the respective image forming units 54 develop electrostatic latent images formed on the surfaces of the photoconductors 111 with toner of specific colors, that is, yellow (Y), cyan (C), magenta (M), and black (K), respectively. Thus, a full-color toner image is formed using the four image forming units 54. Specifically, the toner images formed on the surfaces of the photoconductors 111 are sequentially transferred onto the intermediate transfer belt 51 one atop the other by primary transfer rollers 15Y, 15C, 15M, and 15K (hereinafter collectively referred to as primary transfer rollers 15), each supplied with a transfer bias and provided opposite the respective photoconductors 111 with the intermediate transfer belt 51 interposed therebetween. Accordingly, a single full-color toner image is formed on the intermediate transfer belt 51.

The full-color toner image formed on the intermediate transfer belt 51 is secondarily transferred onto the sheet P by the secondary transfer roller 56. The intermediate transfer belt 51 is then cleaned by the belt cleaning device 59. A transfer bias is supplied to the secondary transfer roller 56 to form a transfer electric field between the secondary transfer roller 56 and the third roller 55 with the intermediate transfer belt 51 interposed therebetween. Thus, the full-color toner image formed on the intermediate transfer belt 51 is secondarily transferred from the intermediate transfer belt 51 onto the sheet P conveyed to a nip formed between the secondary transfer roller 56 and the intermediate transfer belt 51. After secondary transfer of the full-color toner image from the intermediate transfer belt 51 onto the sheet P, the sheet P having the full-color toner image thereon is conveyed to the fixing device 16 to fix the full-color toner image to the sheet P. Then, the sheet P having the fixed full-color image thereon is discharged to the discharge storage 17.

In the image forming apparatus 200 according to illustrative embodiments, before being discharged to the discharge storage 17, the sheet P having the fixed image thereon passes the cooling device 18 disposed immediately after the fixing device 16. When passing the cooling device 18, the sheet P heated by the fixing device 16 contacts the cooling plates 1a and 1b. At this time, heat is absorbed from the sheet P by heat-absorbing surfaces of the cooling plates 1a and 1b that face the sheet P. The heat thus absorbed by the cooling plates 1a and 1b is transmitted to the liquid coolant flowing through the cooling plates 1a and 1b. The liquid coolant heated by the heat transmitted from the cooling plates 1a and 1b is then discharged from the cooling plates 1a and 1b to be conveyed to the radiator 103 having the cooling fan 104 via the tank 101 and the pump 100. The heat released from the liquid coolant by the radiator 103 is discharged outside the image forming apparatus 200. After the heat is released from the liquid coolant by the radiator 103 and the temperature of the liquid coolant is lowered to room temperature, the liquid coolant is conveyed to the cooling plates 1b and 1a again. The above-described heat releasing cycle having good cooling capability using the liquid coolant can efficiently cool the sheet P heated by the fixing device 16.

As a result, when the sheet P is stored in the discharge storage 17, toner on the sheet securely hardens and is fixed onto the sheet P. In particular, blocking, which tends to occur during duplex image formation in which the fixing device 16 performs the fixing process twice for each sheet P, can be reliably prevented by use of the cooling device 18.

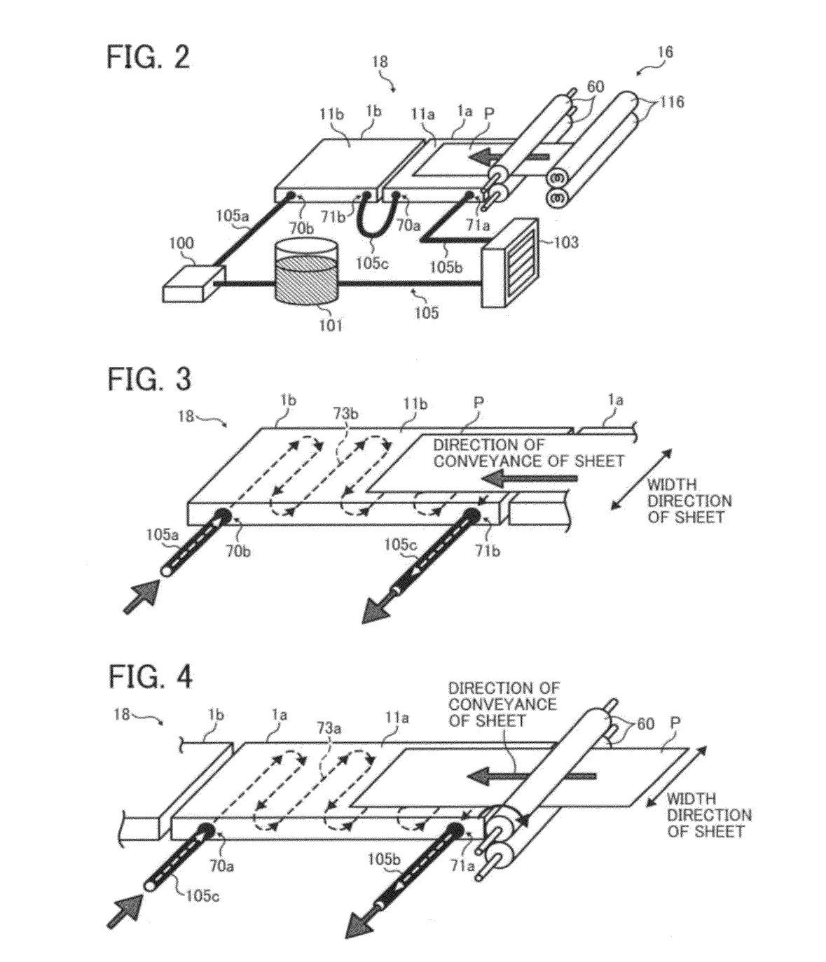

FIG. 2 is a schematic view illustrating an example of an overall configuration of the cooling device 18 according to the first illustrative embodiment.

In the first illustrative embodiment, the pump 100, the radiator 103, the tank 101, and cooling members, which, in the present illustrative embodiment, are the cooling plates 1a and 1b, are connected to one another by the tubing 105 constructed of rubber tubes. A serpentine liquid circulation channel is formed within each of the cooling plates 1a and 1b.

FIG. 3 is a schematic view illustrating an example of a configuration around the cooling plate 1b in the cooling device 18 according to the first illustrative embodiment.

An inlet 70b from which the liquid coolant enters the cooling plate 1b is provided at a downstream end on a lateral surface of the cooling plate 1b in a direction of conveyance of the sheet P. An outlet 71b from which the liquid coolant is discharged from the cooling plate 1b is provided at an upstream end on the lateral surface of the cooling plate 1b. The inlet 70b and outlet 71b of the cooling plate 1b are connected to respective ends of a serpentine internal channel 73b formed within the cooling plate 1b in a width direction of the sheet P perpendicular to the direction of conveyance of the sheet P. One end of a tube 105a is connected to the pump 100, and the other end thereof is connected to the inlet 70b. One end of a tube 105c is connected to the outlet 71b.

FIG. 4 is a schematic view illustrating an example of a configuration around the cooling plate 1a in the cooling device 18 according to the first illustrative embodiment.

An inlet 70a from which the liquid coolant enters the cooling plate 1a is provided at a downstream end on a lateral surface of the cooling plate 1a in the direction of conveyance of the sheet P. An outlet 71a from which the liquid coolant is discharged from the cooling plate 1a is provided at an upstream end on the lateral surface of the cooling plate 1a. The inlet 70a and outlet 71a of the cooling plate 1a are connected to respective ends of a serpentine internal channel 73a formed within the cooling plate 1a in the width direction of the sheet P. The one end of the tube 105c is connected to the outlet 71b of the cooling plate 1b, and the other end thereof is connected to the inlet 70a of the cooling plate 1a. One end of a tube 105b is connected to the radiator 103, and the other end thereof is connected to the outlet 71a.

Thus, the inlet 70a and outlet 71a are provided on the same lateral surface of the cooling plate 1a, and the inlet 70b and outlet 71b are provided on the same lateral surface of the cooling plate 1b. Accordingly, all the tubes 105a, 105b, and 105c can be disposed on one side of the cooling plates 1a and 1b in the width direction of the sheet P, thereby simplifying placement of the tubing 105 within the cooling device 18 and achieving a space-saving configuration.

The liquid coolant stored in the tank 101 is conveyed by the pump 100 so as to enter the cooling plate 1b from the inlet 70b via the tube 105a. The liquid coolant absorbs heat while flowing through the cooling plate 1b, and is discharged from the cooling plate 1b to the tube 105c via the outlet 71b. The liquid coolant thus discharged then enters the cooling plate 1a from the inlet 70a via the tube 105c. The liquid coolant absorbs heat while flowing through the cooling plate 1a, and is discharged from the cooling plate 1a to the tube 105b via the outlet 71a. The liquid coolant heated by heat absorbed from the cooling plates 1a and 1b while flowing through the cooling plates 1a and 1b is then conveyed to the radiator 103 so that the heat is released from the liquid coolant. Thereafter, the liquid coolant sufficiently cooled by the radiator 103 is returned to the tank 101.

The fixing device 16 includes a pair of heat rollers 116 having a heater therein. The full-color toner image is fixed to the sheet P by heat supplied from the pair of heat rollers 116. The sheet P thus heated is conveyed by a pair of conveyance rollers 60 to the cooling device 18. In the cooling device 18, the sheet P contacts an upper surface of each of the cooling plates 1a and 1b, that is, heat-absorbing surfaces 11a and 11b, while being conveyed. At this time, the cooling plates 1a and 1b absorb heat from the sheet P contacting the heat-absorbing surfaces 11a and 11b using thermal transmission to cool the sheet P.

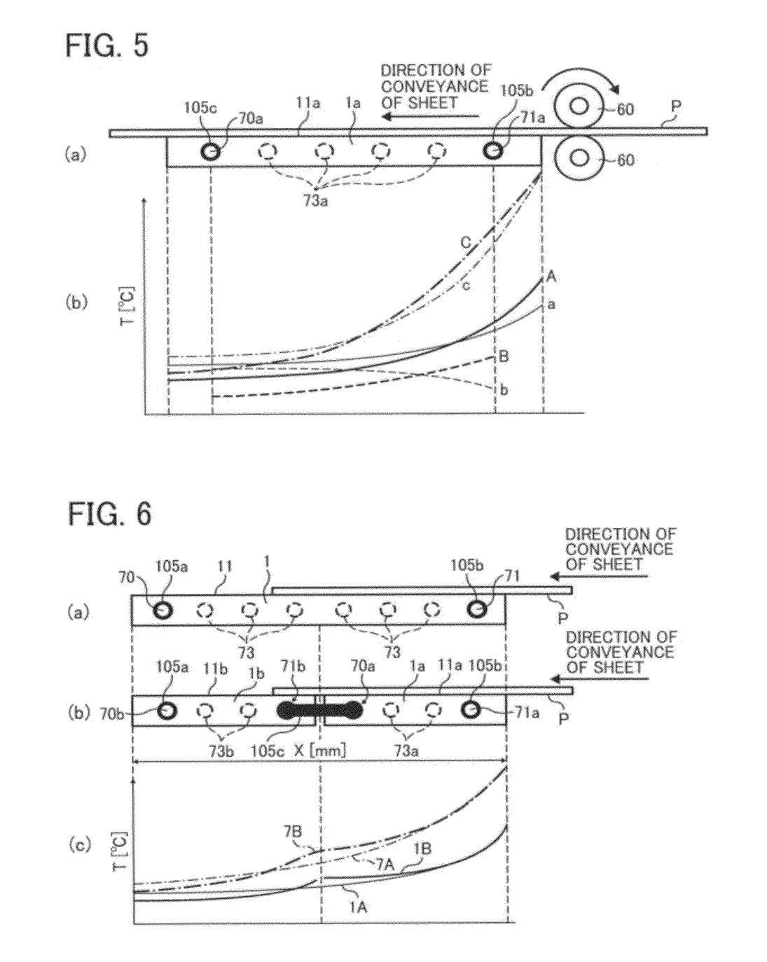

FIG. 5(a) is a side view illustrating the configuration around the cooling plate 1a, and FIG. 5(b) is a graph showing temperature distribution in the direction of conveyance of the sheet P corresponding to the configuration illustrated in FIG. 5(a). It is to be noted that, in the graph shown in FIG. 5(b), the horizontal axis represents position in the direction of conveyance of the sheet P and the vertical axis represents temperature.

The sheet P heated by the pair of heat rollers 116 is conveyed by the pair of conveyance rollers 60 to the cooling plate 1a so that the sheet P is cooled by the cooling plate 1a while contacting the heat-absorbing surface 11a of the cooling plate 1a. Accordingly, temperature distribution in the direction of conveyance of the sheet P occurs in the cooling plate 1a that absorbs heat from the sheet P.

Each of bold lines A, B, and C in FIG. 5(b) indicates temperature distribution in the case of the first illustrative embodiment as described above, in which the liquid coolant enters the cooling plate 1a from the inlet 70a, flows through the cooling plate 1a through the internal channel 73a, and then is discharged from the cooling plate 1a via the outlet 71a. In other words, the liquid coolant flows through the cooling plate 1a from downstream to upstream in the direction of conveyance of the sheet P.

The bold solid line A in FIG. 5(b) indicates temperature distribution in the cooling plate 1a in the direction of conveyance of the sheet P. The bold broken line B in FIG. 5(b) indicates temperature distribution in the liquid coolant flowing through the cooling plate 1a in the direction of conveyance of the sheet P. The bold broken line C in FIG. 5(b) indicates temperature distribution in the sheet P in the direction of conveyance thereof.

Meanwhile, each of fine lines a, b, and c in FIG. 5(b) indicates temperature distribution in a configuration according to a comparative example, in which the liquid coolant enters the cooling plate 1a from the outlet 71a, flows through the cooling plate 1a through the internal channel 73a, and is then discharged from the cooling plate 1a via the inlet 70a. Thus, in the comparative example, the liquid coolant flows through the cooling plate 1a from upstream to downstream in the direction of conveyance of the sheet P, which is the reverse of the configuration employed in the first illustrative embodiment.

The fine solid line a in FIG. 5(b) indicates temperature distribution in the cooling plate 1a in the direction of conveyance of the sheet P according to the comparative example. The fine broken line b in FIG. 5(b) indicates temperature distribution in the liquid coolant flowing through the cooling plate 1a in the direction of conveyance of the sheet P according to the comparative example. The fine broken line c in FIG. 5(b) indicates temperature distribution in the sheet P in the direction of conveyance thereof according to the comparative example.

As is clear from FIG. 5(b), at the upstream end of the cooling plate 1a, the temperature of the cooling plate 1a according to the first illustrative embodiment indicated by the bold solid line A is higher than that according to the comparative example indicated by the fine solid line a. By contrast, at the downstream end of the cooling plate 1a, the temperature of the cooling plate 1a according to the first illustrative embodiment is lower than that according to the comparative example. The above difference in temperature distribution in the cooling plate 1a between the first illustrative embodiment and the comparative example reflects the temperature of the liquid coolant flowing through the cooling plate 1a.

When the liquid coolant enters the cooling plate 1a from the inlet 70a provided at the downstream end of the cooling plate 1a, liquid coolant at its coolest flows around the downstream end of the cooling plate 1a as indicated by the bold broken line B. Then, the liquid coolant absorbs heat while flowing through the cooling plate 1a from downstream to upstream so that the temperature of the liquid coolant is gradually increased toward the upstream end of the cooling plate 1a. When hottest, the liquid coolant is discharged from the outlet 71a provided at the upstream end of the cooling plate 1a.

By contrast, when the liquid coolant enters the cooling plate 1a from the outlet 71a provided at the upstream end of the cooling plate 1a, liquid coolant at its coolest flows around the upstream end of the cooling plate 1a as indicated by the fine broken line b. Then, the liquid coolant absorbs heat while flowing through the cooling plate 71a from upstream to downstream so that the temperature of the liquid coolant is gradually increased toward the downstream end of the cooling plate 71a. When hottest, the liquid coolant is discharged from the inlet 70a provided at the downstream end of the cooling plate 1a.

Thus, in the case of the first illustrative embodiment, in which the liquid coolant flows through the cooling plate 1a from downstream to upstream, the downstream end of the cooling plate 1a has a lower temperature and the upstream end thereof has a higher temperature compared to the case of the comparative example, in which the liquid coolant flows through the cooling plate 1a from upstream to downstream.

The above difference in temperature distribution in the cooling plate 1a between the first illustrative embodiment and the comparative example affects cooling efficiency. Comparing the bold broken line C to the fine broken line c, at the upstream portion of the cooling plate 1a, that is, at the start of cooling of the sheet P, the temperature of the sheet P according to the comparative example indicated by the fine broken line c is lower than that according to the first illustrative embodiment indicated by the bold broken line C. However, at the downstream portion of the cooling plate 1a, that is, at the end of cooling of the sheet P, a temperature of the sheet P according to the first illustrative embodiment is lower than that according to the comparative example. The reason for the lower temperature of the sheet P at the downstream portion of the cooling plate 1a according to the first illustrative embodiment is that the sheet P contacts a portion of the heat-absorbing surface 11a having the lower temperature at the downstream end of the cooling plate 1a.

In order to prevent blocking, the sheet P needs to be cooled as low as possible by the cooling device 18 before being discharged to the discharge storage 17. Therefore, it is preferable that the downstream end of the cooling plate 1a, which cools the sheet P in the last stage of cooling operation performed by the cooling plate 1a, have a lower temperature even if the upstream end of the cooling plate 1a has a rather higher temperature.

Thus, in the first illustrative embodiment, the liquid coolant enters the cooling plate 1a from the inlet 70a provided at the downstream end of the cooling plate 1a and flows through the cooling plate 1a through the internal channel 73a in a direction opposite the direction of conveyance of the sheet P. Thereafter, the liquid coolant is discharged from the cooling plate 1a via the outlet 71a provided at the upstream end of the cooling plate 1a. As a result, a decrease in cooling efficiency at the downstream end of the cooling plate 1a can be prevented, thereby efficiently cooling the sheet P.

In the first illustrative embodiment, in a manner similar to the cooling plate 1a, the liquid coolant enters the cooling plate 1b from the inlet 70b provided at the downstream end of the cooling plate 1b and flows through the cooling plate 1b through the internal channel 73b in the direction opposite the direction of conveyance of the sheet P. Thereafter, the liquid coolant is discharged from the cooling plate 1b via the outlet 71b provided at the upstream end of the cooling plate 1b. As a result, a decrease in cooling efficiency at the downstream end of the cooling plate 1b can be also prevented, thereby efficiently cooling the sheet P.

Because the fixing device 16 melts the toner by heat from the pair of heat rollers 116 to fix the toner image to the sheet P, moisture contained in the sheet P is evaporated, resulting in an increase in humidity around the fixing device 16. Consequently, if the upstream end of the cooling plate 1a provided near the pair of heat rollers 116 is too cool, a difference in temperature between the cooling plate 1a and the pair of heat rollers 116 is increased too much, thereby easily causing condensation on the surface of the cooling plate 1a at the upstream end thereof.

By contrast, when the liquid coolant flows through the cooling plate 1a from downstream to upstream as in the case of the first illustrative embodiment, the temperature at the upstream end of the cooling plate 1a is increased, thereby reducing the difference in temperature between the pair of heat rollers 116 and the cooling plate 1a. Accordingly, condensation on the surface of the cooling plate 1a at the upstream end thereof can be prevented.

In addition, the split configuration incorporating an interval between the cooling plates 1a and 1b provides further cooling efficiency, particularly compared to a configuration employing a single continuous cooling plate, as is described below with reference to FIG. 6.

FIG. 6(a) is a side view illustrating an example of a configuration of a single cooling plate 1 provided to a cooling device according to a second comparative example. The cooling plate 1 has a length of X mm in the direction of conveyance of the sheet P. FIG. 6(b) is a side view illustrating the configuration of the cooling plates 1a and 1b arranged side by side at an interval therebetween in the direction of conveyance of the sheet P according to the first illustrative embodiment. The cooling plates 1a and 1b are respectively disposed in two separate ranges obtained by dividing a single range having the length of X mm into the two ranges. FIG. 6(c) is a graph showing temperature distribution corresponding to the configurations respectively illustrated in FIGS. 6(a) and 6(b). It is to be noted that in the graph shown in FIG. 6(c), the horizontal axis represents position in the direction of conveyance of the sheet P and the vertical axis represents temperature.

In the case of the second comparative example in which the single cooling plate 1 is provided as illustrated in FIG. 6(a), the liquid coolant enters the cooling plate 1 from an inlet 70 provided at a downstream end on a lateral surface of the cooling plate 1, flows through the cooling plate 1 through an internal channel 73, and is then discharged from the cooling plate 1 via an outlet 71 provided at an upstream end on the lateral surface of the cooling plate 1.

In the case of the first illustrative embodiment, in which the two separate cooling plates 1a and 1b are provided side by side at an interval therebetween in the direction of conveyance of the sheet P as illustrated in FIG. 6(b), first, the liquid coolant enters the cooling plate 1b from the inlet 70b provided at the downstream end of the cooling plate 1b, flows through the cooling plate 1b through the internal channel 73b, and is then discharged from the cooling plate 1b via the outlet 71b provided at the upstream end of the cooling plate 1b to the tube 105c. Next, the liquid coolant discharged to the tube 105c enters the cooling plate 1a from the inlet 70a provided at the downstream end of the cooling plate 1a, flows through the cooling plate 1a through the internal channel 73a, and is then discharged from the cooling plate 1a via the outlet 71a provided at the upstream end of the cooling plate 1a to the tube 105b.

Fine lines 1A and 7A in FIG. 6(c) indicate temperature distribution in the case of the second comparative example in which the single cooling plate 1 is provided as illustrated in FIG. 6(a). Specifically, the fine solid line 1A indicates temperature distribution in the cooling plate 1 in the direction of conveyance of the sheet P. The fine broken line 7A indicates temperature distribution in the sheet P in the direction of conveyance thereof.

Bold lines 1B and 7B in FIG. 6(c) indicate temperature distribution in the case of the first illustrative embodiment in which the cooling plates 1a and 1b are arranged side by side at an interval therebetween in the direction of conveyance of the sheet P as illustrated in FIG. 6(b). Specifically, the bold solid line 1B indicates temperature distribution in the cooling plates 1a and 1b in the direction of conveyance of the sheet P. The bold broken line 7B indicates temperature distribution in the sheet P in the direction of conveyance thereof.

Compared to the temperature of the cooling plate 1 indicated by the fine solid line 1A, the temperature of the cooling plate 1a indicated by the bold solid line 1B is higher overall and the temperature of the cooling plate 1b also indicated by the bold solid line 1B is lower overall.

The reason for the lower temperature of the cooling plate 1b is that the interval provided between the cooling plates 1a and 1b prevents thermal transmission between the cooling plates 1a and 1b. Assuming that the cooling plates 1a and 1b are that contacts with each other without an interval therebetween, thermal transmission between the cooling plates 1a and 1b occurs. Consequently, temperature distribution is equalized between the cooling plates 1a and 1b, resulting in the similar temperature distribution obtained in the case of the second comparative example in which the single cooling plate 1 is provided as illustrated in FIG. 6(a).

As described above, in order to reduce the temperature of the sheet P discharged to the discharge storage 17, it is more effective that a portion which cools the sheet P at the last stage of cooling operation has a lower temperature. The two separate cooling plates 1a and 1b according to the first illustrative embodiment, which are arranged side by side at an interval therebetween in the direction of conveyance of the sheet P, can prevent thermal transmission from the upstream cooling plate 1a to the downstream cooling plate 1b and the temperature increase at the downstream end of the cooling plate 1b. Accordingly, the cooling plates 1a and 1b can more effectively cool the sheet P compared to the case in which the sheet P is cooled by the single cooling plate 1. As a result, a temperature increase in the liquid coolant flowing through the downstream end of the cooling plate 1b can also be prevented, thereby efficiently and effectively cooling the sheet P even at the downstream end of the cooling plate 1b.

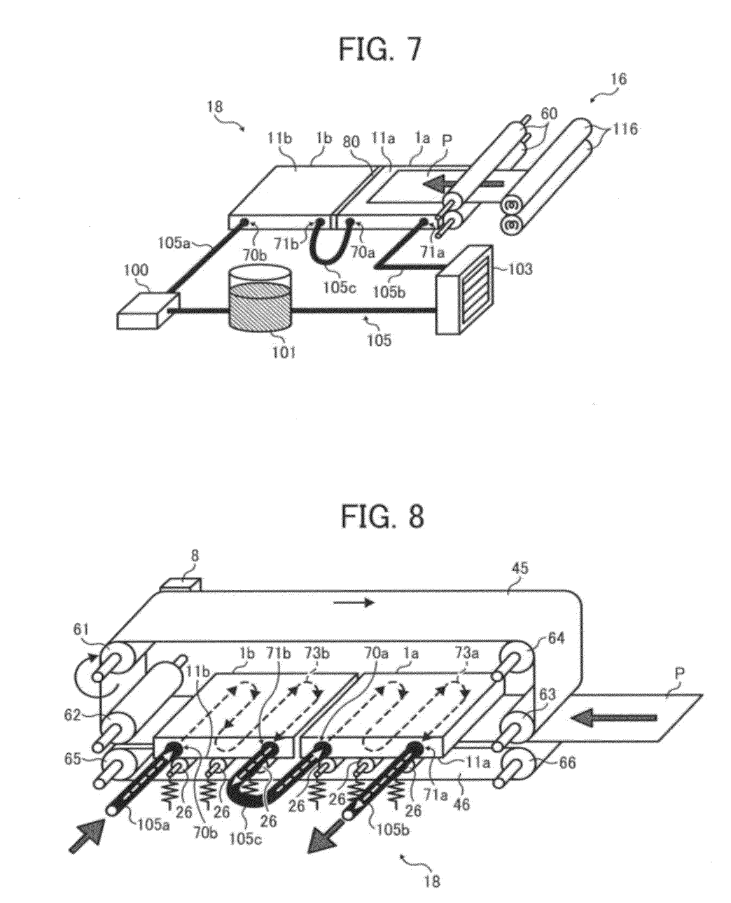

Alternatively, in a variation illustrated in FIG. 7, a thermal insulator 80 may be provided between the cooling plates 1a and 1b to prevent thermal transmission between the cooling plates 1a and 1b. In such a case, the same effects as those obtained by the first illustrative embodiment described above can be achieved.

A description is now given of a second illustrative embodiment of the present invention. FIG. 8 is a perspective view illustrating an example of a configuration around the cooling plates 1a and 1b provided to the cooling device 18 according to the second illustrative embodiment.

In the second illustrative embodiment, a polyimide cooling belt 45 is rotatably wound around a drive roller 61 and multiple driven rollers 62, 63, and 64. In addition, a conveyance belt 46 would around driven rollers 65 and 66 is provided opposite the cooling belt 45. The conveyance belt 46 is formed of an elastic material such as acrylic rubber or polyimide, or has a multi-layered structure formed of the elastic material and polyimide. The sheet P is conveyed, while sandwiched between the cooling belt 45 and the conveyance belt 46, by the cooling belt 45 rotated by a drive force from the drive roller 61 and the conveyance belt 46 rotated as the cooling belt 45 rotates.

The two separate cooling plates 1a and 1b arranged side by side at an interval therebetween in the direction of conveyance of the sheet P and connected with each other by the tube 105c are fixed to contact an inner circumference of the cooling belt 45. The cooling plates 1a and 1b contact the inner circumference of the cooling belt 45 rotated by the drive roller 61 to absorb heat, via the cooling belt 45, from the sheet P conveyed by the cooling belt 45 and the conveyance belt 46.

The inlet 70b from which the liquid coolant enters the cooling plate 1b is provided at the downstream end on the lateral surface of the cooling plate 1b. The outlet 71b from which the liquid coolant is discharged from the cooling plate 1b is provided at the upstream end on the lateral surface of the cooling plate 1b. The inlet 70b and outlet 71b of the cooling plate 1b are connected to the respective ends of the serpentine internal channel 73b formed within the cooling plate 1b in the width direction of the sheet P. One end of the tube 105a is connected to the pump 100, and the other end thereof is connected to the inlet 70b. One end of the tube 105c is connected to the outlet 71b.

The inlet 70a from which the liquid coolant enters the cooling plate 1a is provided at the downstream end on the lateral surface of the cooling plate 1a. The outlet 71a from which the liquid coolant is discharged from the cooling plate 1a is provided at the upstream end on the lateral surface of the cooling plate 1a. The inlet 70a and outlet 71a of the cooling plate 1a are connected to the respective ends of the serpentine internal channel 73a formed within the cooling plate 1a in the width direction of the sheet P. One end of the tube 105c is connected to the outlet 71b of the cooling plate 1b, and the other end thereof is connected to the inlet 70a of the cooling plate 1a. One end of the tube 105b is connected to the radiator 103, and the other end thereof is connected to the outlet 71a of the cooling plate 1a.

The liquid coolant enters the cooling plate 1b via the tube 105a and is discharged from the cooling plate 1b to the tube 105c. Then, the liquid coolant thus discharged from the cooling plate 1b enters the cooling plate 1a via the tube 105c and is discharged from the cooling plate 1a to the tube 105b.

Multiple pressing rollers 26, each contacting an inner circumference of the conveyance belt 46 to press the conveyance belt 46 against the cooling plates 1a and 1b, are provided inside the loop of the conveyance belt 46. Accordingly, an outer circumference of the cooling belt 45 more reliably contacts the sheet P and the cooling plates 1a and 1b more reliably contact the inner circumference of the cooling belt 45. Further, the cooling belt 45 and the conveyance belt 46 more securely convey the sheet P.

The sheet P sandwiched and conveyed by the cooling belt 45 and the conveyance belt 46 is cooled by the cooling plates 1a and 1b via a thermal transmission member, which, in the present illustrative embodiment, is the cooling belt 45. As a result, the sheet P does not slide against the cooling plates 1a and 1b, thereby preventing blots or blurs on the sheet P caused by sliding against the cooling plates 1a and 1b.

In a manner similar to the first illustrative embodiment, in the second illustrative embodiment the liquid coolant flows through the two separate cooling plates 1b and 1a from downstream to upstream, that is, the liquid coolant flows from the cooling plate 1b to the cooling plate 1a, so as to cool the sheet P by the cooling plates 1a and 1b using the liquid coolant. As a result, the downstream end of the cooling plate 1b which cools the sheet P in the last stage of cooling operation has a lower temperature, thereby efficiently cooling the sheet P. In addition, as described previously in the first illustrative embodiment, use of the two separate cooling plates 1a and 1b arranged side by side at an interval therebetween can more effectively cool the sheet P compared to the case in which the single cooling plate 1 is used.

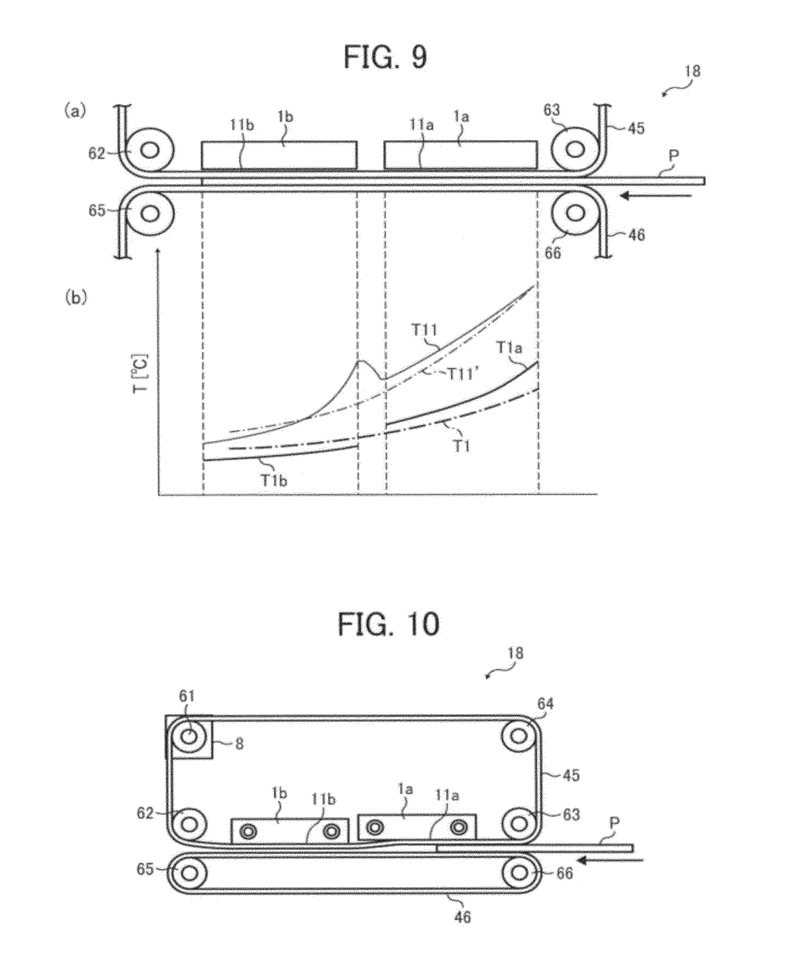

FIG. 9(a) is a side view illustrating the configuration around the cooling plates 1a and 1b in the cooling device 18 according to the second illustrative embodiment, and FIG. 9(b) is a graph showing temperature distribution corresponding to the configuration illustrated in FIG. 9(a).

While the sheet P having a higher temperature heated by the fixing device 16 is conveyed by the cooling belt 45 and the conveyance belt 46, the heat-absorbing surfaces 11a and 11b of the cooling plates 1a and 1b slidably contact the inner circumference of the cooling belt 45 and absorb heat from the sheet P via the cooling belt 45.

At this time, temperature distribution occurs in both the cooling plates 1a and 1b. A fine solid line T11 in FIG. 9(b) indicates temperature distribution in a target surface of the sheet P to be cooled, that is, an upper surface of the sheet P. A bold solid line T1a indicates temperature distribution in the heat-absorbing surface 11a (the lower surface) of the cooling plate 1a, and the bold solid line T1b indicates temperature distribution in the heat-absorbing surface 11b (the lower surface) of the cooling plate 1b.

A fine broken line T11′ indicates temperature distribution in the target surface of the sheet P in a case of a comparative example in which the cooling plates 1a and 1b are arranged side by side to contact each other without an interval therebetween. A bold broken line T1 indicates temperature distribution in the heat-absorbing surfaces (the lower surfaces) 11a and 11b of the cooling plates 1a and 1b in the case of the comparative example.

As described previously in the first illustrative embodiment, thermal transmission between the cooling plates 1a and 1b does not occur when the cooling plates 1a and 1b are disposed in upstream and downstream sides within the cooling device 18 in the direction of conveyance of the sheet P, respectively, with an interval therebetween. Therefore, compared to the case of the comparative example, the upstream cooling plate 1a has a higher temperature and the downstream cooling plate 1b has a lower temperature in the second illustrative embodiment.

The temperature of the downstream end of the cooling plate 1b considerably affects the temperature of the sheet P discharged from the cooling device 18. Therefore, the cooling plate 1b having a lower temperature can more effectively cool the sheet P even if the temperature of the cooling plate 1a is somewhat higher.

After the sheet P passes the cooling plate 1a, the temperature of the sheet P is increased by heat retained by the sheet P while the sheet P passes through the interval between the cooling plates 1a and 1b because the sheet P is not cooled in that interval. The higher the temperature of the sheet P, the cooling members such as the cooling plates 1a and 1b more easily absorb heat from the sheet P. Therefore, the temperature increase in the sheet P at the interval between the cooling plates 1a and 1b is advantageous for the cooling device 18 to cool the sheet P.

Thus, the sheet P is more effectively cooled by the cooling plates 1a and 1b disposed at an interval therebetween compared to the case in which the cooling plates 1a and 1b are disposed to contact with each other without an interval therebetween.

It is preferable that the heat-absorbing surfaces 11a and 11b of the cooling plates 1a and 1b be disposed on the same level with a difference in height of not greater than 100 μm.

FIG. 10 is a vertical cross-sectional view illustrating an example of a configuration of the cooling device 18 according to the second illustrative embodiment in a case in which the cooling plates 1a and 1b are not appropriately disposed but instead are vertically offset from each other. When the heat-absorbing surfaces 11a and 11b of the cooling plates 1a and 1b are disposed with a difference in height and do not together form a single flush surface as illustrated in FIG. 10, a gap is generated between the cooling belt 45 and the cooling plate 1a or 1b. In the example illustrated in FIG. 10, there is a gap between the cooling belt 45 and the downstream portion of the cooling plate 1a. Consequently, the sheet P cannot be cooled by the cooling plate 1a at that portion where the gap exists. In addition, a step between the cooling plates 1a and 1b causes large loads on the cooling belt 45, resulting in rapid deterioration of the cooling belt 45.

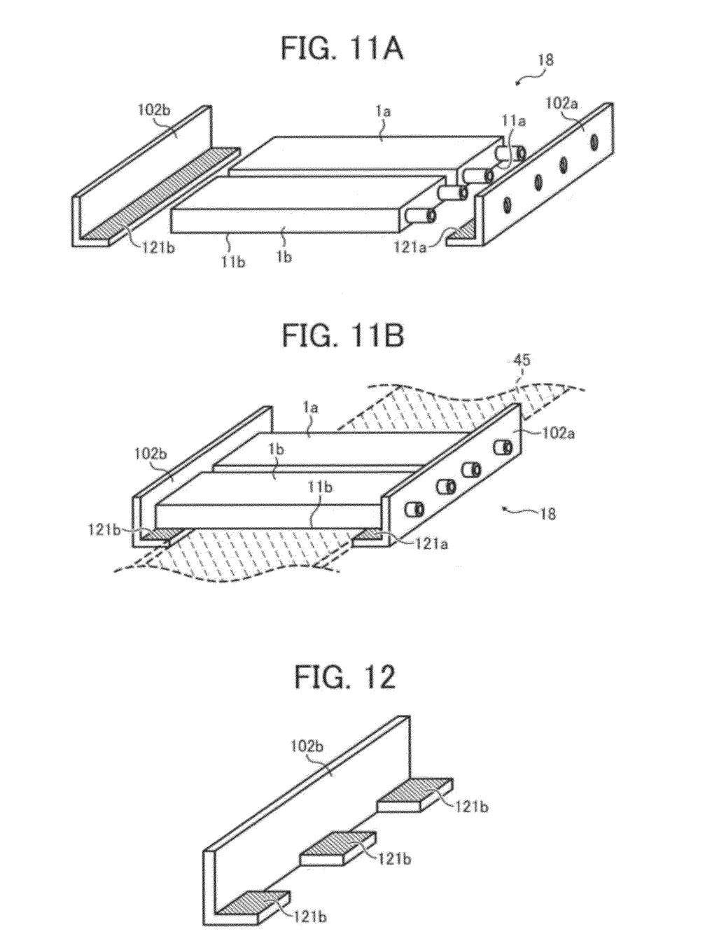

FIGS. 11A and 11B are perspective views illustrating an example of a configuration of positioning members 102a and 102b provided to the cooling device 18. Specifically, FIG. 11A is a perspective view illustrating a state in which the cooling plates 1a and 1b are not yet placed on the positioning members 102a and 102b, and FIG. 11B is a perspective view illustrating a state in which the cooling plates 1a and 1b are placed on the positioning members 102a and 102b.

Both the heat-absorbing surfaces 11a and 11b of the cooling plates 1a and 1b are placed on the same surface of each of the positioning members 102a and 102b so as to dispose the heat-absorbing surfaces 11a and 11b at substantially the same height.

Each of the positioning members 102a and 102b has an L-shape in cross-section and includes a positioning surface 121a or 121b on which the cooling plates 1a and 1b are placed. As illustrated in FIG. 11B, both the positioning surfaces 121a and 121b are positioned outside the both edges of the cooling belt 45 in a width direction of the cooling belt 45.

Alternatively, although only the positioning member 102b is shown as a representative example in FIG. 12, each of the positioning surfaces 121a and 121b of the positioning member 102a and 102b may have cutouts, as long as a desired flatness is obtained at a contact surface in which the positioning surface 121a or 121b contacts the cooling plates 1a and 1b. As a result, the heat-absorbing surfaces 11a and 11b of the cooling plates 1a and 1b are disposed on the same level with a difference in height of not greater than 100 μm.

As described above, in the second illustrative embodiment, the sheet P is sandwiched and conveyed by the cooling belt 45 and the conveyance belt 46, each of which is wound around the multiple rollers. The cooling plates 1a and 1b are arranged side by side at an interval therebetween in the direction of conveyance of the sheet P to slidably contact the inner circumference of the cooling belt 45. Alternatively, the cooling plates 1a and 1b may be disposed to contact the inner circumferences of the cooling belt 45 and the conveyance belt 46, respectively. Such a configuration is described in detail later in a third illustrative embodiment.

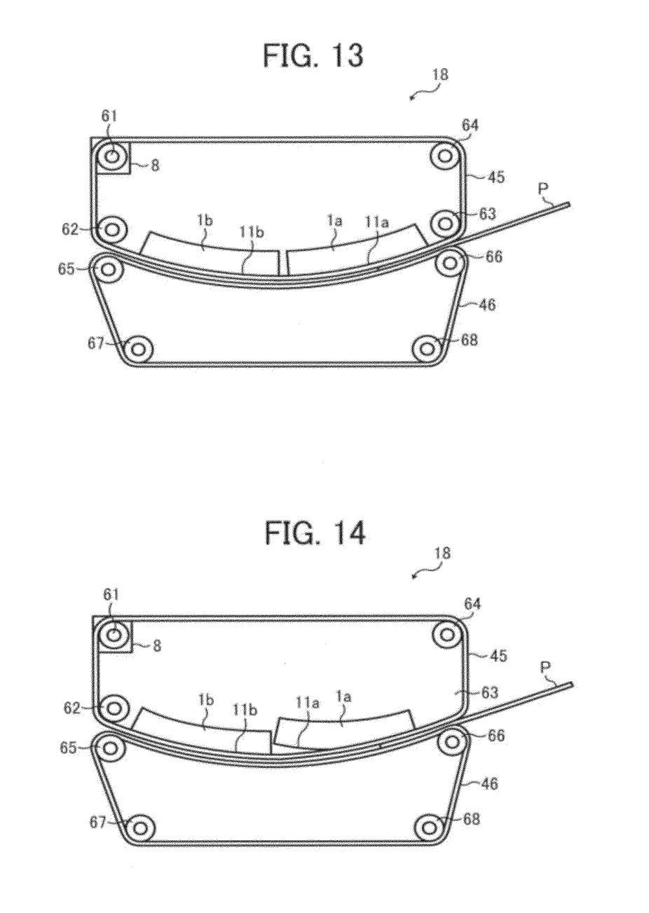

A description is now given of a first variation of the second illustrative embodiment. FIG. 13 is a vertical cross-sectional view illustrating an example of a configuration of the cooling device 18 according to the first variation of the second illustrative embodiment.

As illustrated in FIG. 13, each of the heat-absorbing surfaces 11a and 11b of the cooling plates 1a and 1b are convexly curved. Accordingly, the heat-absorbing surfaces 11a and 11b more evenly contact the inner circumference of the cooling belt 45.

The cooling plates 1a and 1b have the same shape, and each of the heat-absorbing surfaces 11a and 11b has an even curvature radius. Thus, the heat-absorbing surfaces 11a and 11b can more easily be disposed to together form a single flat stepless plane, and such a configuration can be easily achieved even when number of cooling members is increased to three, four, and so on.

In addition to the driven rollers 65 and 66, driven rollers 67 and 68 are provided so that the conveyance belt 46 is wound around the four rollers 65, 66, 67, and 68. Thus, both the cooling belt 45 and the conveyance belt 46 more evenly contact the sheet P. As a result, the cooling device 18 can be more effectively cool the sheet P.

The following problems occur when the cooling plates 1a and 1b are not optimally arranged inside the loop of the cooling belt 45 and the heat-absorbing surfaces 11a and 11b of the cooling plates 1a and 1b do not together form a single flat plane. In a manner similar to the example illustrated in FIG. 10, a gap is generated between the cooling belt 45 and the cooling plate 1a or 1b around the interval between the cooling plates 1a and 1b. In the example illustrated in FIG. 14, there is a gap between the cooling belt 45 and the downstream portion of the cooling plate 1a. Because the cooling plate 1a does not contact the cooling belt 45 at the downstream portion where the gap exists, the sheet P cannot be cooled at that portion. In addition, a step between the cooling plates 1a and 1b causes large loads on the cooling belt 45, resulting in rapid deterioration of the cooling belt 45.

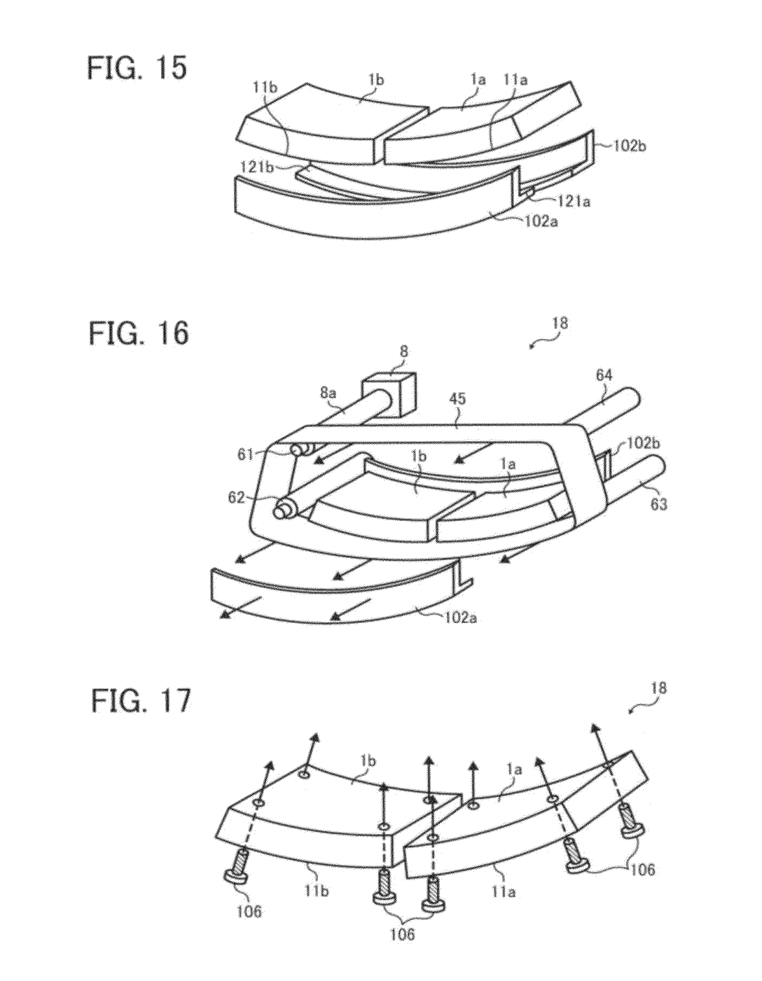

To solve the above problems, the cooling device 18 according to the first variation of the second illustrative embodiment includes the positioning members 102a and 102b as illustrated in FIG. 15. The positioning members 102a and 102b have the positioning surfaces 121a and 121b, respectively, each of which has the same curvature as the heat-absorbing surfaces 11a and 11b of the cooling plates 1a and 1b. The cooling plates 1a and 1b are placed on the positioning surfaces 121a and 121b of the positioning members 102a and 102b. As a result, the cooling plates 1a and 1b are appropriately disposed such that the heat-absorbing surfaces 11a and 11b together form a single curved stepless plane.

Alternatively, each of the curved positioning surfaces 121a and 121b may have cutouts in a manner similar to the example illustrated in FIG. 12 as long as a desired outline is obtained at a contact surface in which the positioning surface 121a or 121b contacts the heat-absorbing surfaces 11a and 11b of the cooling plates 1a and 1b. Further alternatively, the positioning member 102a may be detachably installed in the cooling device 18 as illustrated in FIG. 16 such that the positioning member 102a is detached from the cooling device 18 upon replacement of the cooling belt 45, thereby facilitating attachment and detachment of the cooling belt 45 to and from the cooling device 18. In the example illustrated in FIG. 16, each of the positioning member 102a and the cooling belt 45 is detached from the cooling device 18 in a direction indicated by arrows, that is, a direction opposite a drive motor 8 in an axial direction of a drive roller 8a.

A description is now given of a second variation of the second illustrative embodiment with reference to FIG. 17. FIG. 17 is a schematic view illustrating how to fix the cooling plates 1a and 1b to the cooling device 18.

As described previously, when the cooling plates 1a and 1b are not appropriately positioned inside the loop of the cooling belt 45, there may be a gap between the cooling belt 45 and the cooling plate 1a or 1b. Consequently, the sheet P cannot be effectively cooled by the cooling plate 1a or 1b and the cooling belt 45 may be damaged.

To solve the above problems, in the second variation of the second illustrative embodiment, the cooling plates 1a and 1b are fixed to the cooling device 18 without the positioning members 102a and 102b.

Specifically, each of the cooling plates 1a and 1b has a fastening point at each corner thereof into which an adjustment member, that is, a fastening screw 106, is inserted to fix the cooling plates 1a and 1b to the cooling device 18. The adjustment member can adjust a position and an angle of each of the cooling plates 1a and 1b. A fastening depth of each of the screws 106 is adjusted at each fastening point such that a height and an angle of each of the cooling plates 1a and 1b relative to the cooling device 18 can be finely adjusted. As a result, the heat-absorbing surfaces 11a and 11b of the cooling plates 1a and 1b together form a single curved stepless plane.

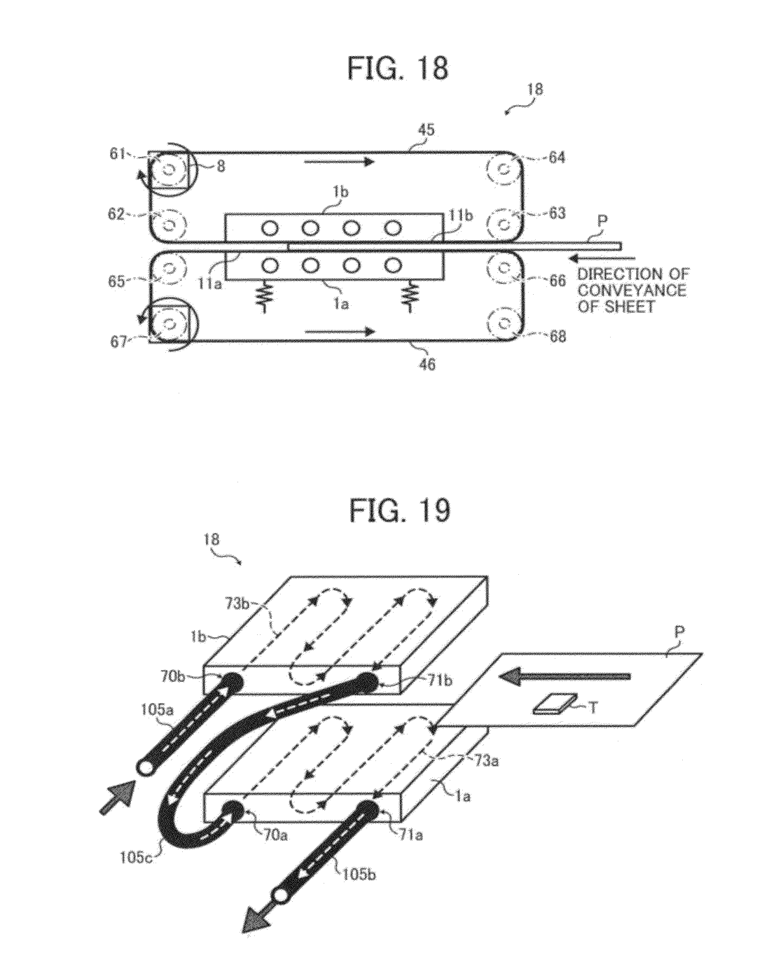

A description is now given of a third illustrative embodiment of the present invention with reference to FIG. 18. FIG. 18 is a vertical cross-sectional view illustrating an example of a configuration of the cooling device 18 according to the third illustrative embodiment. In the third illustrative embodiment, the cooling plates 1a and 1b are disposed vertically one above the other.

As illustrated in FIG. 18, the cooling belt 45 is rotatably wound around the drive roller 61 and the multiple driven rollers 62, 63, and 64. In addition, the conveyance belt 46 is rotatably wound around the drive roller 67 and the multiple driven rollers 65, 66, and 68. The cooling plate 1a is provided opposite the cooling plate 1b with both the cooling belt 45 and the conveyance belt 46 interposed therebetween so that both upper and lower surfaces of the sheet P can be cooled by the cooling plates 1b and 1a, respectively, at the same time.

As a result, the sheet P heated by the fixing device 16 can be more efficiently cooled by the cooling plates 1a and 1b from both the upper and lower surfaces of the sheet P, thereby achieving good cooling efficiency in a shorter cooling path.

FIG. 19 is a schematic view illustrating an example of a flow of the liquid coolant in the cooling plates 1a and 1b provided to the cooling device 18 illustrated in FIG. 18.

The inlet 70b from which the liquid coolant enters the cooling plate 1b is provided at the downstream end on the lateral surface of the cooling plate 1b provided above the cooling plate 1a. The outlet 71b from which the liquid coolant is discharged from the cooling plate 1b is provided at the upstream end on the lateral surface of the cooling plate 1b. The inlet 70b and outlet 71b of the cooling plate 1b are connected to the respective ends of the serpentine internal channel 73b formed within the cooling plate 1b in the width direction of the sheet P. One end of the tube 105a is connected to the pump 100, and the other end thereof is connected to the inlet 70b. One end of the tube 105c is connected to the outlet 71b.

The inlet 70a from which the liquid coolant enters the cooling plate 1a is provided at the downstream end on the lateral surface of the cooling plate 1a provided below the cooling plate 1b. The outlet 71a from which the liquid coolant is discharged from the cooling plate 1a is provided at the upstream end on the lateral surface of the cooling plate 1a. The inlet 70a and outlet 71a of the cooling plate 1a are connected to the respective ends of the serpentine internal channel 73a formed within the cooling plate 1a in the width direction of the sheet P. One end of the tube 105c is connected to the outlet 71b of the cooling plate 1b, and the other end thereof is connected to the inlet 70a of the cooling plate 1a. One end of the tube 105b is connected to the radiator 103, and the other end thereof is connected to the outlet 71a of the cooling plate 1a.

The liquid coolant enters the cooling plate 1b from the inlet 70b provided at the downstream end of the cooling plate 1b, flows through the cooling plate 1b through the internal channel 73b, and is then discharged from the cooling plate 1b via the outlet 71b provided at the upstream end of the cooling plate 1b to the tube 105c. The liquid coolant thus discharged to the tube 105c then enters the cooling plate 1a, which is provided below the cooling plate 1b, from the inlet 70a provided at the downstream end of the cooling plate 1a and connected to the tube 105c, flows through the cooling plate 1a through the internal channel 73a, and is discharged from the cooling plate 1a via the outlet 71a provided at the upstream end of the cooling plate 1a to the tube 105b. Thus, the liquid coolant sequentially flows through the cooling plates 1b and 1a.

As illustrated in FIG. 19, when an image is formed only on an upper surface of the sheet P, a toner image T is fixed to the upper surface of the sheet P by the pair of fixing rollers 116. Therefore, the liquid coolant having a lower temperature first flows through the cooling plate 1b which faces the upper surface of the sheet P having the fixed toner image T thereon. As a result, the temperature of the cooling plate 1b can be kept lower, thereby more efficiently cooling the toner image T formed on the upper surface of the sheet P.

In addition, because the sheet P is cooled by the cooling plates 1a and 1b from both the upper and lower surfaces thereof, an amount of heat absorbed from the sheet P by each of the cooling plates 1a and 1b at the upstream portions thereof is reduced compared to the case in which both the cooling plates 1a and 1b are disposed side by side on the single side of the sheet P, that is, either above or below the conveyance path of the sheet P. As a result, an amount of heat transmitted from upstream to downstream in each of the cooling plates 1a and 1b is also reduced, thereby preventing a temperature increase in the downstream end of each of the cooling plates 1a and 1b. Accordingly, a temperature increase in the liquid coolant flowing at the downstream end of each of the cooling plates 1a and 1b, which cools the sheet P in the last stage of cooling operation, can be prevented, thereby efficiently cooling the sheet P even at the downstream end of each of the cooling plates 1a and 1b.

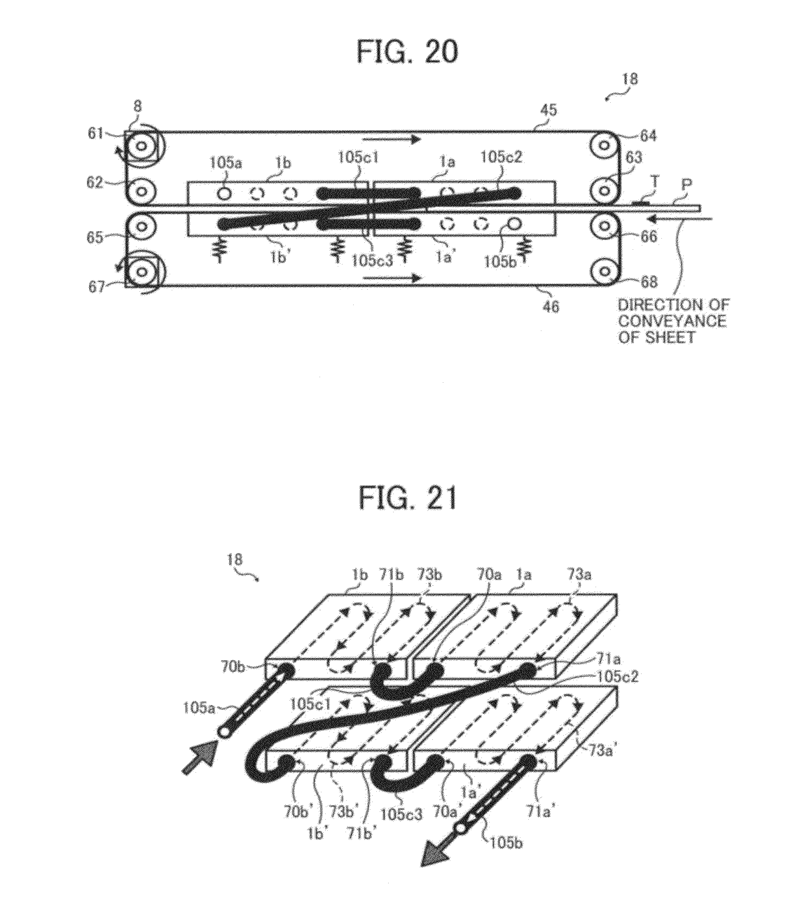

A description is now given of a first variation of the third illustrative embodiment. FIG. 20 is a schematic view illustrating an example of a configuration of the cooling device 18 according to the first variation of the third illustrative embodiment. In the cooling device 18 illustrated in FIG. 20, the two separate cooling plates 1a and 1b arranged side by side at an interval therebetween in the direction of conveyance of the sheet P and connected with each other by a tube 105c1 are fixed to contact the inner circumference of the cooling belt 45. In addition, a second pair of cooling plates 1a′ and 1b′ arranged side by side at an interval therebetween in the direction of conveyance of the sheet P and connected with each other by a tube 105c3 are fixed to contact an inner circumference of the conveyance belt 46.

The liquid coolant first flows through the cooling plates 1b and 1a provided above the second pair of cooling plates 1b′ and 1a′, and then flows through the cooling plates 1b′ and 1a′.

Specifically, as illustrated in FIG. 21, the liquid coolant enters the cooling plate 1b from the inlet 70b provided at the downstream end on the lateral surface of the cooling plate 1b, flows through the cooling plate 1b through the internal channel 73b, and then is discharged to the tube 105c1 from the cooling plate 1b via the outlet 71b provided at the upstream end on the lateral surface of the cooling plate 1b. Next, the liquid coolant discharged to the tube 105c1 enters the cooling plate 1a from the inlet 70a provided at the downstream end on the lateral surface of the cooling plate 1a, flows through the cooling plate 1a through the internal channel 73a, and is then discharged to a tube 105c2 from the cooling plate 1a via the outlet 71a provided at the upstream end on the lateral surface of the cooling plate 1a.

Subsequently, the liquid coolant discharged to the tube 105c2 enters the cooling plate 1b′ from an inlet 70b′ provided at a downstream end on a lateral surface of the cooling plate 1b′, flows through the cooling plate 1b′ through an internal channel 73b′, and is then discharged to the tube 105c3 from the cooling plate 1b′ via an outlet 71b′ provided at an upstream end on the lateral surface of the cooling plate 1b′. Thereafter, the liquid coolant discharged to the tube 105c3 enters the cooling plate 1a′ from an inlet 70a′ provided at a downstream end on a lateral surface of the cooling plate 1a′, flows through the cooling plate 1a′ through an internal channel 73a′, and is then discharged to the tube 105b from the cooling plate 1a′ via an outlet 71a′ provided at an upstream end on the lateral surface of the cooling plate 1a′.

Thus, the liquid coolant having a lower temperature first flows through the cooling plates 1b and 1a, each of which faces the upper surface of the sheet P having the fixed toner image T thereon. As a result, the cooling plates 1a, 1b, 1a′ and 1b′ can efficiently absorb heat from both the upper and lower surfaces the sheet P to effectively cool the sheet P. In addition, the temperature of each of the cooling plates 1a and 1b provided above the cooling plates 1a′ and 1b′ can be kept lower, thereby more efficiently cooling the toner image T formed on the upper surface of the sheet P.

Further, thermal transmission from the cooling plate 1a or 1a′, each of which is provided upstream from the cooling plate 1b or 1b′, to the cooling plate 1b or 1b′ can be prevented. Accordingly, a temperature increase in the downstream end of the cooling plate lb or 1b′ can be prevented. As a result, a temperature increase in the liquid coolant flowing through the downstream end of each of the cooling plates 1b and 1b′, which cools the sheet P in the last stage of cooling operation, can be prevented, thereby efficiently and effectively cooling the sheet P even at the downstream end of each of the cooling plates 1b and 1b′.

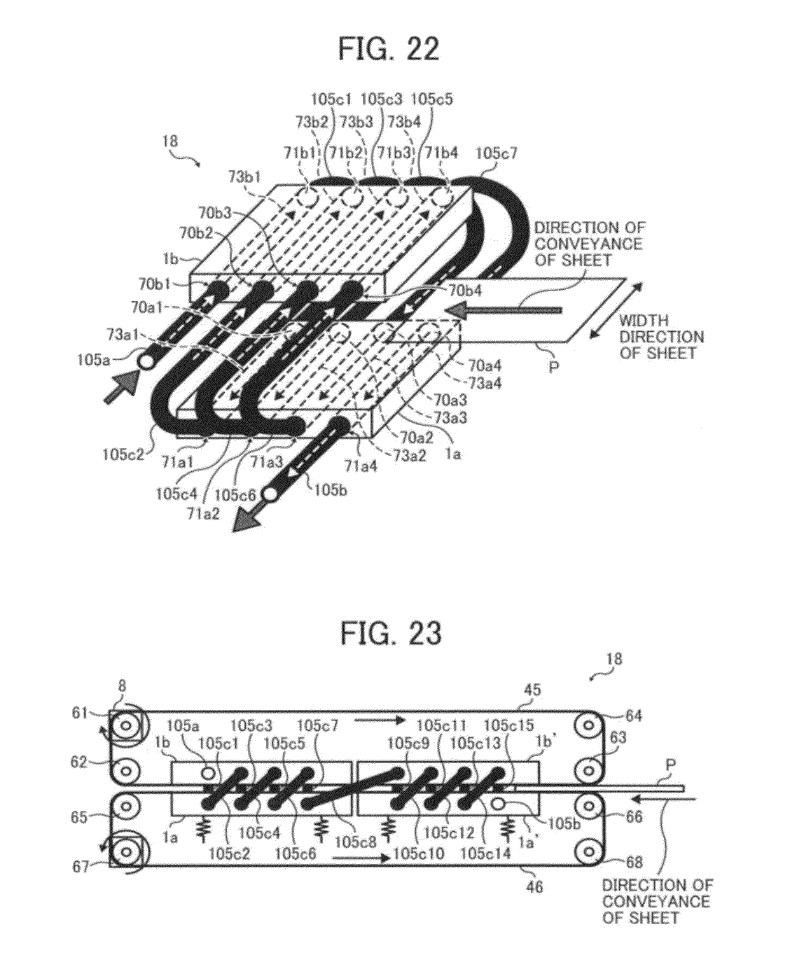

A description is now given of a second variation of the third illustrative embodiment. FIG. 22 is a schematic view illustrating an example of a flow of the liquid coolant in the cooling device 18 according to the second variation of the third illustrative embodiment.

In the cooling plate 1b provided above the cooling plate 1a, multiple internal channels 73b1, 73b2, 73b3, and 73b4 are provided, in that order, from downstream to upstream in the direction of conveyance of the sheet P. Each of the internal channels 73b1, 73b2, 73b3, and 73b4 passes through the cooling plate 1b in the width direction of the sheet P perpendicular to the direction of conveyance of the sheet P. One end of each of the internal channels 73b1, 73b2, 73b3, and 73b4 is connected to inlets 70b1, 70b2, 70b3, and 70b4, respectively, and the other end of each of the internal channels 73b1, 73b2, 73b3, and 73b4 is connected to outlets 71b1, 71b2, 71b3, and 71b4, respectively.

In a manner similar to the cooling plate 1b, in the cooling plate 1a provided below the cooling plate 1b, multiple internal channels 73a1, 73a2, 73a3, and 73a4 are provided, in that order, from downstream to upstream in the direction of conveyance of the sheet P, and each of the internal channels 73a1, 73a2, 73a3, and 73a4 passes through the cooling plate 1a in the width direction of the sheet P. One end of each of the internal channels 73a1, 73a2, 73a3, and 73a4 is connected to inlets 70a1, 70a2, 70a3, and 70a4, respectively, and the other end of each of the internal channels 73a1, 73a2, 73a3, and 73a4 is connected to outlets 71a1, 71a2, 71a3, and 71a4, respectively.

One end of the tube 105a is connected to the pump 100, and the other end thereof is connected to the inlet 70b1. The outlet 71b1 and the inlet 70a1 are connected to the respective ends of the tube 105c1, and the outlet 71a1 and the inlet 70b2 are connected to the respective ends of the tube 105c2. The outlet 71b2 and the inlet 70a2 are connected to the respective ends of the tube 105c3, and the outlet 71a2 and the inlet 70b3 are connected to the respective ends of a tube 105c4. The outlet 71b3 and the inlet 70a3 are connected to the respective ends of a tube 105c5, and the outlet 71a3 and the inlet 70b4 are connected to the respective ends of a tube 105c6. The outlet 71b4 and the inlet 70a4 are connected to the respective ends of a tube 105c7. One end of the tube 105b is connected to the radiator 103, and the other end thereof is connected to the outlet 71a4.

The liquid coolant enters the cooling plate 1b from the inlet 70b1 provided at the extreme downstream side on the lateral surface of the cooling plate 1b, alternately flows between the cooling plates 1b and 1a in a spiral manner, and is ultimately discharged from the cooling plate 1a via the outlet 71a4 provided at the extreme upstream side on the lateral surface of the cooling plate 1a.

As a result, the temperature of each of the cooling plates 1a and 1b is further reduced at the downstream end of each of the cooling plates 1a and 1b, and a difference in temperature between the cooling plates 1a and 1b can be reduced, thereby evenly cooling both the upper and lower surfaces of the sheet P.

In addition, because the sheet P is cooled by the cooling plates 1a and 1b from both the upper and lower surfaces thereof, an amount of heat absorbed from the sheet P by each of the cooling plates 1a and 1b at the upstream portions thereof is reduced compared to the case in which both the cooling plates 1a and 1b are disposed side by side on the single side of the sheet P, that is, either above or below the conveyance path of the sheet P. As a result, an amount of heat transmitted from upstream to downstream in each of the cooling plates 1a and 1b is also reduced, thereby preventing a temperature increase in the downstream end of each of the cooling plates 1a and 1b. Accordingly, a temperature increase in the liquid coolant flowing through the downstream end of each of the cooling plates 1a and 1b, which cools the sheet P in the last stage of cooling operation, can be prevented, thereby efficiently and effectively cooling the sheet P even at the downstream end of each of the cooling plates 1a and 1b.

A description is now given of a third variation of the third illustrative embodiment. FIG. 23 is a vertical cross-sectional view illustrating an example of a configuration of the cooling device 18 according to the third variation of the third illustrative embodiment.

In the cooling device 18 illustrated in FIG. 23, the two separate cooling plates 1b and 1b′ arranged side by side at an interval therebetween in the direction of conveyance of the sheet P are fixed to contact the inner circumference of the cooling belt 45. The cooling plate 1b is provided downstream from the cooling plate 1b′. In addition, the two separate cooling plates 1a and 1a′ arranged side by side at an interval therebetween in the direction of conveyance of the sheet P are fixed to contact the inner circumference of the conveyance belt 46 provided below the cooling belt 45. The cooling plate 1a is provided downstream from the cooling plate 1a′.

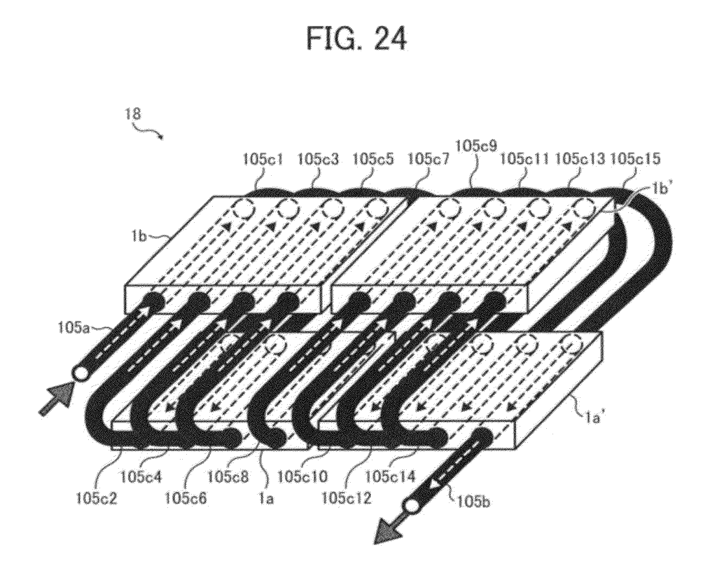

As illustrated in FIG. 24, the liquid coolant enters the cooling plate 1b through the tube 105a connected to the downstream end on the lateral surface of the cooling plate 1b, and alternately flows between the cooling plates 1b and 1a in a spiral manner through the tubes 105c1 to 105c7 from downstream to upstream. Next, the liquid coolant discharged from the cooling plate 1a is conveyed to the cooling plate 1b′ via a tube 105c8, one end of which is connected to the upstream end on the lateral surface of the cooling plate 1a and the other end of which is connected to the downstream end on the lateral surface of the cooling plate 1b′. Thereafter, the liquid coolant alternately flows between the cooling plates 1b′ and 1a′ in a spiral manner through tubes 105c9 to 105c15 from downstream to upstream, and is ultimately discharged from the cooling plate 1a′ to the tube 105b connected to the upstream end on the lateral surface of the cooling plate 1a′.

As a result, the temperature of each of the cooling plates 1a and 1b is further reduced at the downstream end of each of the cooling plates 1a and 1b. In addition, a difference in temperature between each of the cooling plates 1a and 1b and the cooling plates 1a′ and 1b′ can be reduced, thereby evenly cooling both the upper and lower surfaces of the sheet P.

Further, thermal transmission from the cooling plate 1b′ or 1a′ provided upstream from the cooling plate 1b or 1a to the cooling plate 1b or 1a can be prevented. Accordingly, a temperature increase in the downstream end of the cooling plate 1a or 1b can be prevented. As a result, a temperature increase in the liquid coolant flowing through the downstream end of each of the cooling plates 1a and 1b, which cools the sheet P in the last stage of cooling operation, can be prevented, thereby efficiently and effectively cooling the sheet P even at the downstream end of each of the cooling plates 1a and 1b.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. A cooling device, comprising:
at least two cooling members to cool a recording medium passing thereover, each of the cooling members comprising:
a heat-absorbing surface that directly contacts the recording medium or indirectly contacts the recording medium via a thermal transmission member;
an internal channel provided within each of the cooling members through which a coolant circulates; and
a channel inlet and outlet formed at downstream and upstream ends of each of the cooling members in a direction of conveyance of the recording medium, respectively;
a coolant circulation unit to circulate the coolant; and
tubing that connects the coolant circulation unit to the inlet and outlet and through which the coolant circulates,
wherein one of an interval and a thermal insulator is provided between the cooling members.

2. The cooling device according to claim 1, wherein:
the cooling members are arranged side by side in the direction of conveyance of the recording medium; and
the coolant circulation unit first circulates the coolant to the cooling member disposed on the extreme downstream side in the direction of conveyance of the recording medium.

3. The cooling device according to claim 1, wherein;
the cooling members are disposed opposite each other to sandwich the recording medium therebetween; and
the coolant first flows through one of the cooling members that faces a first surface of the recording medium having an image thereon, and then flows through the other one of the cooling members that faces a second surface of the recording medium opposite the first surface.

4. The cooling device according to claim 1, wherein:
the cooling members are disposed opposite each other to sandwich the recording medium therebetween; and
the coolant alternately flows between the internal channels provided within the cooling members.

5. The cooling device according to claim 1, wherein:
the internal channels formed within each of the cooling members are serpentine; and
both the inlet and outlet are provided on a single lateral surface of each of the cooling members.

6. The cooling device according to claim 1, further comprising a heat releasing part that receives the coolant circulated through the internal channels provided within the cooling members, releases heat from the coolant, and returns the resultant coolant to the internal channels.

7. An image forming apparatus, comprising:
a fixing device to fix an image formed on a recording medium onto the recording medium using heat; and
the cooling device according to claim 1, provided downstream from the fixing device in the direction of conveyance of the recording medium, to cool the recording medium onto which the image is fixed by the fixing device.

8. A cooling device, comprising:
an endless belt to convey a recording medium contacting an outer circumference of the belt by movement of the belt;
at least two cooling members arranged side by side at an interval therebetween in a direction of movement of the belt, the cooling members respectively comprising heat-absorbing surfaces each contacting an inner circumference of the belt within a range in which the outer circumference of the belt contacts the recording medium to cool the recording medium by absorbing heat from the recording medium via the belt; and
a positioning member to position the cooling members flush with each other to form a single plane.

9. The cooling device according to claim 8, wherein the plane is a convex curve.

10. The cooling device according to claim 9, wherein the heat-absorbing surfaces of the cooling members have the same curvature radius.

11. The cooling device according to claim 8, wherein the positioning member comprising a positioning surface on which the cooling members are placed to position the cooling members relative to each other,
ends of each of the heat-absorbing surfaces of the cooling members in a width direction of the belt perpendicular to the direction of movement of the belt contacting the positioning surface outside both edges of the belt in the width direction of the belt,
the positioning surface having a shape that corresponds to a shape of each end of the plane formed by the heat-absorbing surfaces of the cooling members.

12. The cooling device according to claim 11, wherein the positioning member is detachably installable in the cooling device.

13. The cooling device according to claim 8, wherein the positioning member comprises an adjustment member that adjusts installation position and angle of each of the cooling members.

14. The cooling device according to claim 13, wherein the adjustment member is a screw.

15. The cooling device according to claim 8, further comprising a heat releasing part that receives a coolant circulated through internal channels provided within the cooling members, releases heat from the coolant, and returns the resultant coolant to the internal channels.

16. An image forming apparatus, comprising:
a fixing device to fix an image formed on a recording medium onto the recording medium using heat; and
the cooling device according to claim 8, provided downstream from the fixing device in a direction of conveyance of the recording medium, to cool the recording medium onto which the image is fixed by the fixing device.
